(19) United States
(12) Patent Application Publication
(10) Pub. No.: US 2016/0114656 A1
(43) Pub. Date: Apr. 28, 2016

(54) DOOR CURTAIN FOR VEHICLES

(71) Applicant: Hyundai Motor Company, Seoul (KR)

(72) Inventor: Eun Pyo HONG, Seongnam-si (KR)

(21) Appl. No.: 14/860,337

(22) Filed: Sep. 21, 2015

(30) Foreign Application Priority Data
Oct. 28, 2014 (KR) 10-2014-0147142

(51) Int. Cl. B60J 1/20

(52) U.S. Cl. CPC B60J 1/2063; B60J 1/2083; B60J 1/2086

(57) ABSTRACT

A door curtain for a vehicle covers overall surface of a door glass to block sunshine from entering the vehicle completely. An upper frame of the curtain is formed with an inserting coupling end. A push-pull clip assembly, to which a coupling end is separately snap fitted, is installed in a frame of the door glass such that the coupling end is fully inserted into the clip assembly when using the curtain. As a result, the curtain covers the whole surface of the door glass.

### CROSS-REFERENCE TO RELATED APPLICATION

This application claims under 35 U.S.C. §119(a) the benefit of priority to Korean Patent Application No. 10-2014-0147142 filed on Oct. 28, 2014, the entire contents of which are incorporated herein by reference.

### TECHNICAL FIELD

The present disclosure relates to a door curtain (e.g., door window curtain) for a vehicle. More particularly, it relates to a manual door curtain for a vehicle to cover overall surface of a window glass of the vehicle door to block sunshine from entering the vehicle completely.

### BACKGROUND

In order to block sunshine entering a compartment of a vehicle through door glasses, electric-driven or manual curtains are mounted to door panels.

FIG. 1 is a perspective view showing a known manual curtain for a vehicle window and FIG. 2 is a sectional view taken along the line A-A in FIG. 1.

In FIGS. 1 and 2, a reference numeral ‘10’ indicates a curtain.

In general, curtain 10 is stored while being wound around a roll mounted in the door panel and only an upper frame 12 of the curtain 10 is exposed out.

In addition, a hook 22 is integrally mounted to a door glass frame 20 holding the door glass during lifting and lowering of the door glass.

For the use of the curtain 10, when a user holds the upper frame 12 of the curtain 10 and pulls the same up, the curtain 10 is drawn out upward. When the hook 2 of the door glass frame 20 is locked in a fixing hole 14 formed in the upper frame 12 of the curtain 10, the curtain 10 covers the door glass 24 to block sunshine from entering the vehicle.

However, the known manual curtains have following drawbacks.

As shown in FIG. 1, in a state that the hook 22 is locked in the fixing hole 14 of the upper frame 12 of the curtain 10, the curtain 10 does not cover the door glass 24 as long as the vertical length of the hook 22.

Thus, sunshine enters the compartment of a vehicle through the door glass 24 from a gap formed between the upper frame 12 of the curtain 10 and the door glass frame 20, causing discomfort to a passenger.

As such, the known manual curtains do not fully cover the door glass and the light entering the vehicle compartment through the gap deteriorates sunshine blocking performance of the known manual curtains.

Moreover, the protruded and exposed hook from the upper frame of the door glass may affect outer appearance and may serve as a hazard factor in a side collision.

In addition, when locking the curtain to the hook, handling the curtain may be inconvenient, because when rotating the upper frame of the curtain to trace the hook, the upper frame of the curtain may collide with the door glass and produce unwanted noise.

### SUMMARY

Accordingly, the present disclosure has been made in an effort to solve the above-mentioned problems. It is an object of the present disclosure to provide a door curtain for a vehicle such that an upper frame of the curtain is formed with an inserting coupling end. A push-pull clip assembly, to which a coupling end is separately snap fitted, is installed in a frame of the vehicle door glass such that the coupling end is fully inserted into the clip assembly when the curtain is used. As a result, the curtain covers the whole surface of the door glass.

In accordance with an aspect of the present disclosure, there is provided a door curtain including: a clip housing having clip fixing slots formed in front and rear sides and installed in a door glass frame of the vehicle; a clip body having clips formed on front and rear sides coupled in the clip fixing slots of the clip housing to ascend and descend; a push-pull locking device fixing positions when the clip body ascends and is positioned in the clip housing and is drawn out from the clip housing; and an insertion coupling end integrally formed with an upper frame of the curtain and inserted into and locked by the clip body in a snap-fitting way.

The clip housing includes fixing steps integrally formed on both lateral sides of the clip housing and assembling recesses formed on an inner wall of the clip housing accommodating room that is formed in a glass frame of the door and restricting the fixing steps.

The clip fixing slots of the clip housing are formed in a vertical length limiting a vertical stroke of the clip body.

The clip body includes: a main body including clips integrally formed on front and rear sides of the main body and coupled in the clip fixing slots to ascend and descend, and a spring supporting hole formed on upper side of the main body, and coupled in the clip housing to ascend and descend; and curtain coupling hooks integrally formed on two bottom sides of the main body to be bent.

The curtain coupling hooks are inserted into the clip housing and arranged vertically when the clip body ascends and are outwardly bent by own resilient force, are in close contact with the surface of a glass frame of the door, and are arranged horizontally when the clip body descends.

A spring is inserted into the spring supporting hole and is compressed and supported on upper side of the clip housing.

The push-pull locking device includes: a position fixing pin fixed on the upper side of the clip housing to fix positions when the clip body ascends and descends; position fixing pin circulation recesses formed on front and rear sides of a side of the clip body such that the position fixing pin circulates in a locking direction and in a releasing direction; and a pin locking and releasing block protruding from the lower side of each of the position fixing pin circulation recess and having an oblique upper side and a locking recess, into which the position fixing pin is inserted, formed in the lower side of the clip housing.

The position fixing pin circulation recesses include first guide recesses guiding the position fixing pin into the locking recess and second guide recesses guiding the position fixing pin within the locking recess in the releasing direction, while the first and second guide recesses are formed on the bottom of the position fixing pin circulation recesses parallel to each other.

The window curtain for a vehicle according to the present disclosure has the following effects.

First, the inserting coupling end formed on the upper frame of the curtain is fully inserted into and coupled with the push-pull clip assembly installed in the door glass frame, so that the curtain may cover the whole surface of the door glass without any gap, resulting in blocking sunshine from entering the compartment of the vehicle.

Second, the push-pull clip assembly is positioned in the door glass frame such that the elements for fixing the curtain are never exposed out to the exterior, resulting in improved outer appearance.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIGS. 1 and 2 are diagrams of a perspective view and a sectional view showing a known manual curtain for a window of a vehicle.

FIG. 3 is a diagram of an exploded perspective view showing a clip assembly of a door curtain for a vehicle, according to an embodiment of the present invention.

FIG. 4 is a diagram showing an assembled clip assembly of the door curtain for a vehicle, according to the embodiment of the present invention.

FIGS. 5A-5C are diagrams showing a process of assembling the clip assembly of the door curtain for a vehicle to the door glass frame, according to an embodiment of the present invention.

FIGS. 6A-6D and 7A-7C are diagrams illustrating processes of developing and separating of the door curtain of a vehicle, according to an embodiment of the present invention.

It should be understood that the appended drawings are not necessarily to scale, presenting a somewhat simplified representation of various preferred features illustrative of the basic principles of the disclosure. The specific design features of the present disclosure as disclosed herein, including for example, specific dimensions, orientations, locations, and shapes can be determined by the particular intended application and use environment.

In the figures, reference numbers refer to the same or equivalent parts of the present disclosure throughout the several figures of the drawing.

### DETAILED DESCRIPTION

Hereinafter, the present disclosure is described in detail so that those skilled in the art to which the present disclosure pertains can easily carry out the present disclosure.

The present disclosure is made such that a coupling end of a curtain is inserted into a clip assembly in a door glass frame of the vehicle for coupling by pushing and is separated by pulling, so that the curtain may easily cover the whole surface of the door glass.

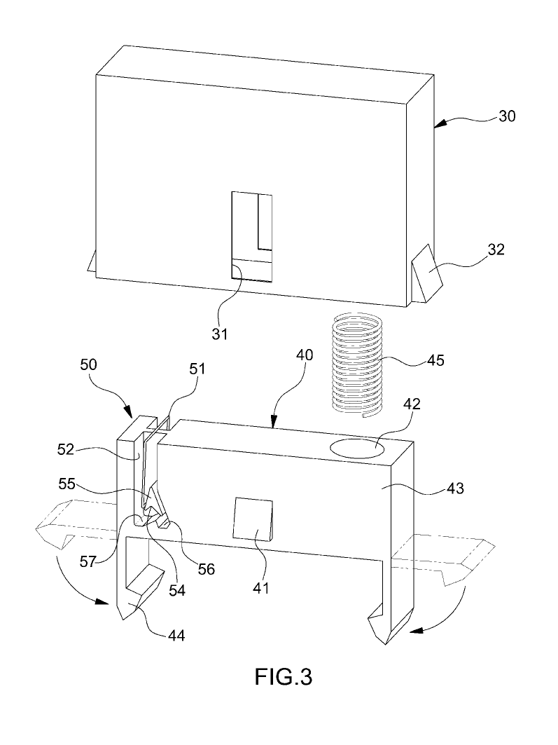

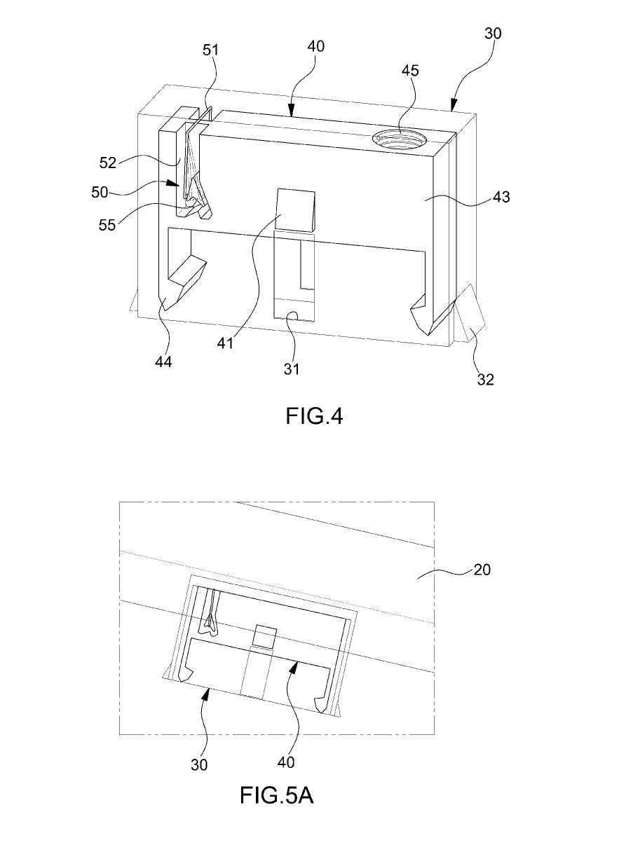

FIG. 3 is a diagram of an exploded perspective view showing a clip assembly of a door curtain for a vehicle, according to an embodiment of the present invention, and FIG. 4 is a diagram showing an assembled clip assembly of the door curtain for a vehicle, according to the embodiment of the present invention.

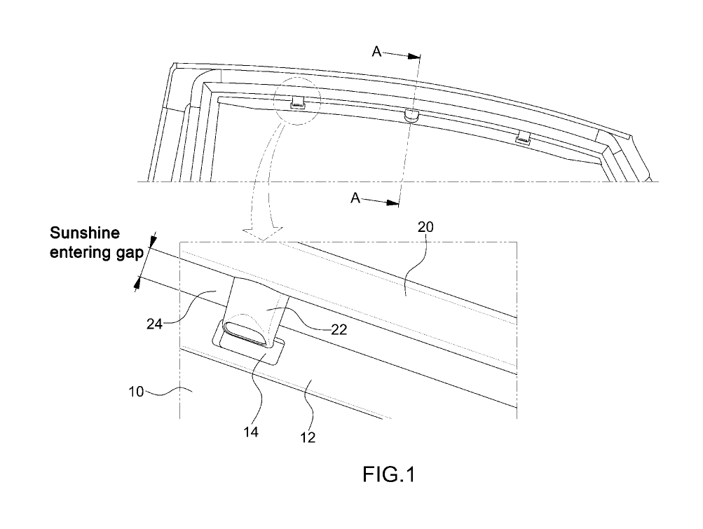

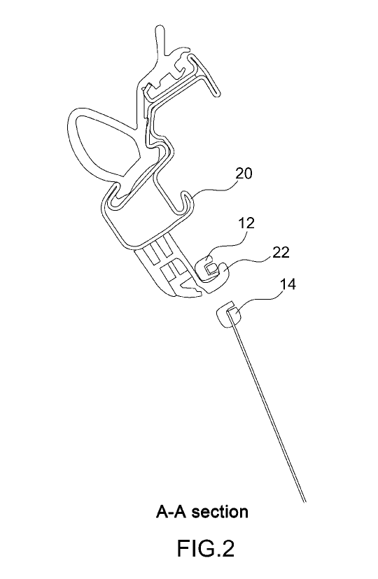

As shown in FIGS. 3 and 4, a reference numeral 30 indicates a clip housing. The clip housing 30 has an opened bottom and front and rear sides penetrated by clip fixing slots 31 and is installed in a door glass frame 20 (shown in FIG. 1).

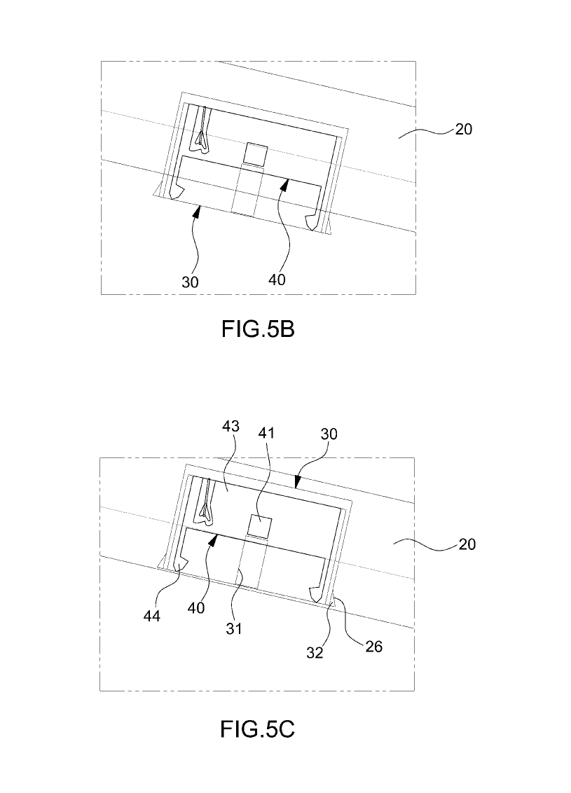

To install the clip housing 30 in the door glass frame 20, the clip housing 30 has fixing steps 32 integrally formed on both sides of the clip housing 30. The door glass frame 20 has a clip housing accommodating room formed therein, and assembling recesses 26 (shown in FIG. 5C) formed in the inner walls of the clip housing accommodating room to restrict the fixing steps 32.

A clip body 40 is inserted into the clip housing 30 to ascend and descend. To this end, the clip body 40 has clips 41 integrally formed with front and rear sides to ascend and descent within the clip fixing slots 31 and a spring supporting hole 42 formed on the upper side, so that the clip body 40 include a main body 43 ascending and descending within the clip housing 30 and foldable curtain coupling hooks 44 integrally formed on both bottom sides of the main body 43.

When the clip body 40 is inserted into the clip housing 30, the clips 41 of the clip body 40 are coupled in the clip fixing slots 31 of the clip housing 30 to ascend and descend.

In this case, since the clip fixing slots 31 of the clip housing 30 have a vertical length limiting the stroke of the clips 41, the vertical stroke of the clip body 40 may be limited.

Moreover, when the clip body 40 is inserted into the clip housing 30, a spring 45 is inserted into the spring supporting hole 42 and is compressed and supported by the upper side of the clip housing 30.

Preferably, the curtain coupling hooks 44 are integrally formed on both bottom sides of the main body 43 such that the curtain coupling hooks 44 maintain horizontality when being bent outward from the two sides of the main body 43 and exhibit a resilient force of returning back to the original horizontality when being bent inward.

Thus, the curtain coupling hooks 44 are bent inward and arranged vertical as being inserted into the clip housing 30 when ascending with the clip body 40, on the contrary, return to their outside original positions due to own resilient force to maintain the horizontality when descending with the clip body 40.

Since the curtain coupling hooks 44 are kept in the horizontality at their original position, the curtain coupling hooks 44 remain in close contact with the surface of the door glass frame 20 without protruding out when seeing from outside.

As such, in the state that the clip body 40 is inserted into the clip housing 30 to ascend and descent, the clip housing 30 is assembled to the door glass frame 20.

FIGS. 5A-5C are diagrams showing a process of assembling the clip assembly of the door curtain for a vehicle to the door glass frame, according to an embodiment of the present invention. Referring to FIGS. 5A-5C, the clip housing 30 is inserted into the clip housing accommodating room formed in the door glass frame 20. The fixing steps 32 formed on both lateral sides of the clip housing 30 are inserted into and locked by the assembling recesses 26 formed in the inner sides of the clip housing accommodating room, so that the clip housing 30 installed with the clip body 40 is assembled in the door glass frame 20.

Meanwhile, since the clip body 40 is inserted into the clip housing 30 to ascend and descend, the ascending and descending of the clip body 40 are carried out in a push-pull way.

The push-pull way means that the clip body 40 is inserted into and fixed in the clip housing 30 when the clip body 40 is pushed and that the clip body 40 descends from the clip housing 30 as a pull way when the clip body 40 is pushed again.

To this end, a push-pull locking device 50 is provided to fix a position when the clip body 40 descends and is positioned in the clip housing 30 and is drawn out from the clip housing 30.

As an element of the push-pull locking device 50, a position fixing pin 51 is fixed on the upper side of the clip housing 30 to fix the position when the clip body 40 ascends and descends.

In more detail, an upper end of the position fixing pin 51 is fixed to the upper side of the clip housing 30 and the lower end thereof is vertically bent and arranged to move along position pin circulation recesses 52.

The position fixing pin circulation recesses 52 are formed on front and rear sides of a lateral side of the clip body 40 such that the position fixing pin 51 may circulate in a locking direction for fixing a descending position of the clip body 40 and in a releasing direction of fixing an ascending position of the clip body 40.

In this case, in the lower side of the position fixing pin circulation recesses 52, a pin locking and releasing block 55 is formed.

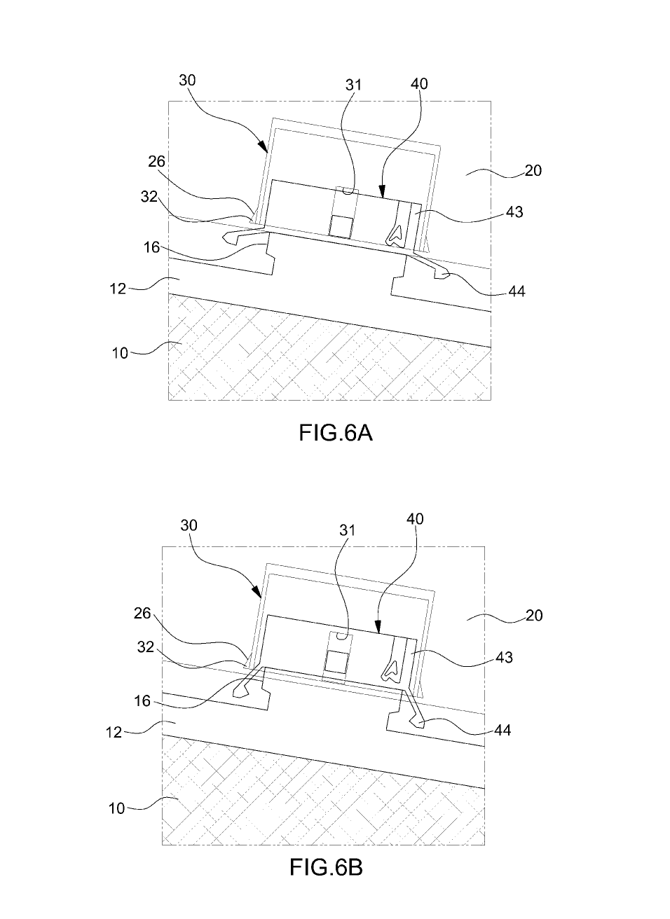

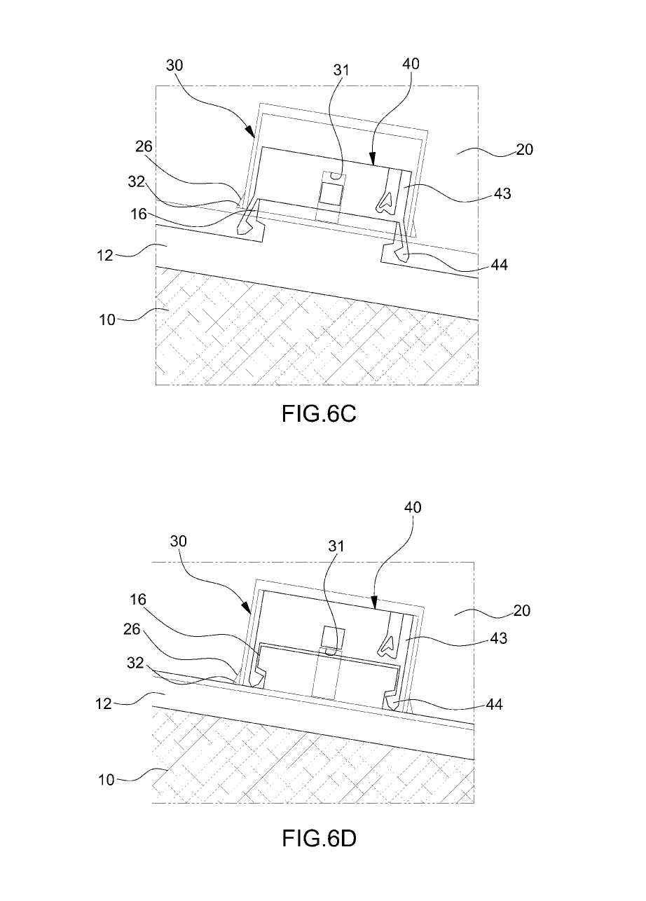

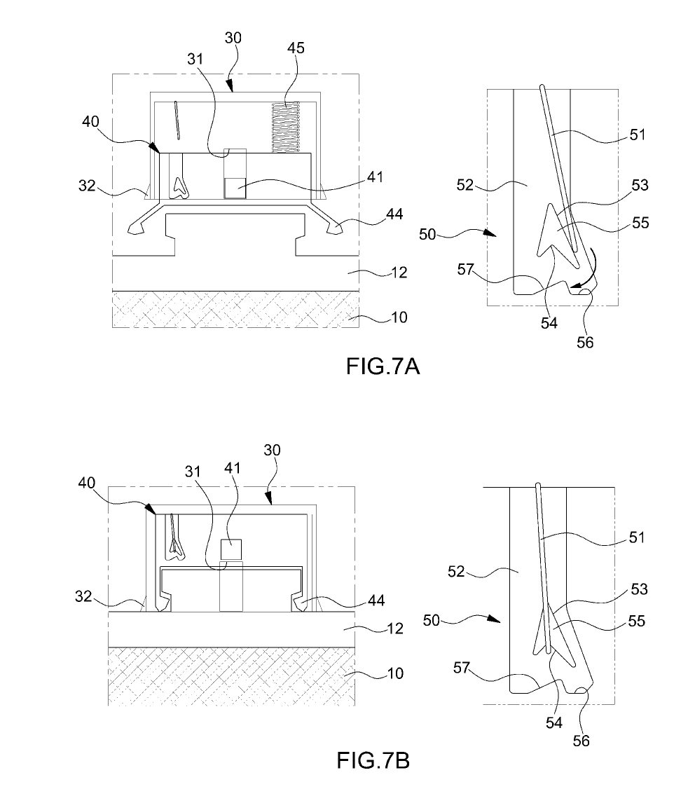

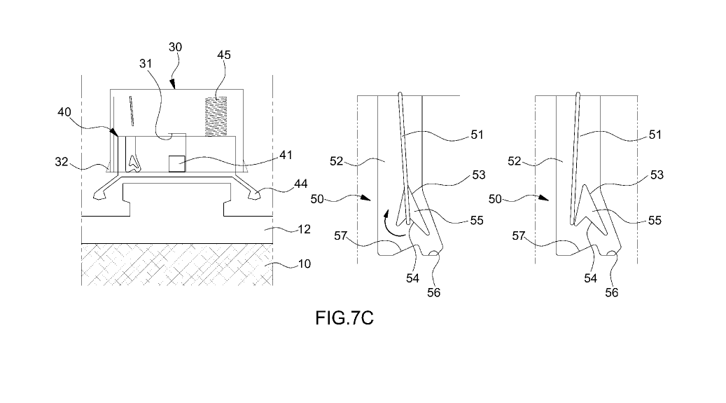

FIGS. 6A-6D and 7A-7C are diagrams illustrating processes of developing and separating of the door curtain of a vehicle, according to an embodiment of the present invention.

As shown in FIGS. 7A-7C, the upper side of the pin locking and releasing block 55 has an oblique side 53 like an oblique side of a triangle and a concave locking recess 54, into which the position fixing pin 51 is inserted, is formed on the lower side thereof.

Moreover, the position fixing pin circulation recesses 52 have first guide recesses 56 guiding the position fixing pin 51 into the locking recess 54 and second guide recesses 57 guiding the position fixing pin 51 within the locking recess 54 in the releasing direction, while the first and second guide recesses 56 and 57 are formed on the bottom of the position fixing pin circulation recesses 52 parallel to each other.

In more detail, as shown in FIGS. 7A-7C, the first guide recesses 56 are oblique downwardly to the locking recess 54 to guide the position fixing pin 51 to the locking recess 54 of the locking and releasing block 55, while the second guide recesses 57 are oblique downwardly to guide the position fixing pin 51 within the locking recess 54 in the releasing direction.

Meanwhile, the upper frame 12 of the curtain 10 is integrally formed with an insertion coupling end 16 inserted and snap-fitted into the clip body 40.

Here, operations of the door curtain for a vehicle according to an embodiment of the present invention will be described with reference to FIGS. 6A-6D and 7A-7C.

First, for use of the curtain, a user pulls the curtain 10 up and matches the coupling end 16 formed in the upper frame 12 of the curtain 10 with an entrance of the clip body 40.

In this case, the curtain coupling hooks 44 are in close contact with the surface of the door glass frame 20.

Next, when the coupling end 16 is pushed into the clip body 40, the clip body 40 ascends within the clip housing 30 with the coupling end 16, and at the same time, the curtain coupling hooks 44 are inserted into the clip housing 30 as following the clip body 40 and are bent vertically.

Next, when the coupling end 16 is fully inserted into the clip body 40, the curtain coupling hooks 44, as shown in a view showing a last operating stage of FIGS. 6A-6D, is inserted into and locked by the locking recess formed in the lower side of the coupling end 16 such that the coupling end 16 is restricted, so that the upper frame 12 of the curtain 10 is in close contact with the door glass frame 20.

As such, since the upper frame 12 of the curtain 10 is in close contact with the door glass frame 20, the curtain 10 covers the whole surface of the door glass, resulting in complete blocking of sunshine from entering the compartment of the vehicle.

In this case, as shown in FIG. 7A, when the clip body 40 ascends within the clip housing 30 simultaneously with the coupling end 16 being inserted into the clip body 40, the position fixing pin 51 descends along the oblique side 53 of the pin locking and releasing block 55 and moves toward the locking recess 54 via the first guide recesses 56.

Next, as shown in FIG. 7B, when the clip body 40 further ascends within the clip housing 30 simultaneously with the coupling end 16 being fully inserted into the clip body 40, the position fixing pin 51 is inserted into and fixed in the locking recess 54 via the first guide recesses 56.

Here, as shown in FIG. 7C, if a user does not want to use the curtain 10, the user pushes the coupling end 16 again using the upper frame 12 of the curtain 10 and then the clip body 40 slightly further ascends and at the same time the position fixing pin 51 moves to the releasing position along the oblique sides of the second guide recesses 56. When the coupling end 16 is released as it is, the position fixing pin 51 is separated from the locking recess 54.

Then, the clip body 40 descends due to the resilient force of the spring 45 and the curtain coupling hooks 44 of the clip body 40 are in close contact with the surface of the door glass frame 20 due to own resilient force again and at the same time the coupling end 16 is released from the coupling hooks 44, so that the curtain 10 descends to a storing position within the door panel.

Although the present disclosure has been described in detail until now, the scope of the present disclosure is not limited to the description but various modifications made by those skilled in the art using the basic concept of the present disclosure defined by the claims also fall within the scope of the present disclosure.

What is claimed is:

1. A door curtain for a vehicle comprising:
a clip housing, having clip fixing slots formed in front and rear sides and installed in a door glass frame of the vehicle;
a clip body, having clips formed on front and rear sides coupled in the clip fixing slots of the clip housing to ascend and descend;
a push-pull locking device, fixing positions when the clip body ascends and is positioned in the clip housing and is drawn out from the clip housing; and
an insertion coupling end, integrally formed with an upper frame of the curtain and inserted into and locked by the clip body in a snap-fitting way.

2. The door curtain of claim 1, wherein the clip housing comprises fixing steps integrally formed on both lateral sides of the clip housing and assembling recesses formed on an inner wall of the clip housing accommodating room that is formed in a glass frame of the door and restricting the fixing steps.

3. The door curtain of claim 1, wherein the clip fixing slots of the clip housing are formed in a vertical length limiting a vertical stroke of the clip body.

4. The door curtain of claim 1, wherein the clip body comprises:
a main body, including clips integrally formed on front and rear sides of the main body and coupled in the clip fixing slots to ascend and descend, and a spring supporting hole formed on upper side of the main body, and coupled in the clip housing to ascend and descend; and
curtain coupling hooks, integrally formed on two bottom sides of the main body to be bent.

5. The door curtain of claim 4, wherein the curtain coupling hooks are inserted into the clip housing and arranged vertically when the clip body ascends and are outwardly bent by own resilient force, are in close contact with the surface of a glass frame of the door, and are arranged horizontally when the clip body descends.

6. The door curtain of claim 4, wherein a spring is inserted into the spring supporting hole and is compressed and supported on upper side of the clip housing.

7. The door curtain of claim 1, wherein the push-pull locking device comprises:
a position fixing pin, fixed on upper side of the clip housing to fix positions when the clip body ascends and descends;
position fixing pin circulation recesses, formed on front and rear sides of a side of the clip body such that the position fixing pin circulates in a locking direction and in a releasing direction; and
a pin locking and releasing block, protruding from lower side of each of the position fixing pin circulation recesses and having an oblique upper side and a locking recess, into which the position fixing pin is inserted, formed in the lower side of the clip housing.

8. The door curtain of claim 7, wherein the position fixing pin circulation recesses include first guide recesses guiding the position fixing pin into the locking recess and second guide recesses guiding the position fixing pin within the locking recess in the releasing direction, while the first and second guide recesses are formed on bottom of the position fixing pin circulation recesses parallel to each other.
